(19) United States
(12) Patent Application Publication
(10) Pub. No.: US 2024/0346945 A1
(43) Pub. Date: Oct. 17, 2024

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventors: Ryosuke NAKANISHI, Nisshin-shi (JP); Hikaru Sugata, Miyoshi-shi (JP); Hideko Yamamoto, Toyota-shi (JP); Eiji Mitsuda, Nagoya-shi (JP)

(73) Assignee: TOYOTA JIDOSHA KABUSHIKI KAISHA, Toyota-shi (JP)

(21) Appl. No.: 18/404,105

(22) Filed: Jan. 4, 2024

(30) Foreign Application Priority Data
Apr. 14, 2023 (JP) 2023-066673

(51) Int. Cl. G09B 7/02

(52) U.S. Cl. CPC G09B 7/02

(57) ABSTRACT

The information processing device includes an information storage unit, a data acquisition unit, and a user characteristic score calculation unit. The information storage unit stores information regarding the user and information regarding the actions of other users. The data acquisition unit acquires information regarding the characteristic item from the information storage unit. The user characteristic score calculation unit includes a self-evaluation score calculation unit, an other-evaluation score calculation unit, and a final evaluation score calculation unit. The self-evaluation score calculation unit calculates a self-evaluation score by the user. The other-evaluation score calculation unit calculates the other-person evaluation score by other users. The final evaluation score calculation unit calculates the user evaluation score based on the weighting coefficient, the self-evaluation score, and the other-person evaluation score.

### CROSS-REFERENCE TO RELATED APPLICATION

This application claims priority to Japanese Patent Application No. 2023-066673 filed on Apr. 14, 2023, incorporated herein by reference in its entirety.

### BACKGROUND

### 1. Technical Field

The present disclosure relates to an information processing device, an information processing method, and a storage medium for evaluating characteristic items of a user.

### 2. Description of Related Art

In social networking services (SNS), a huge amount of data is accumulated everyday through user input and the like. The accumulated data include a plurality of types of data, such as basic information of the user input by the user himself/herself, information (characteristic information) expressing characteristics of the user, and information on interactions with other users. These data may contain contents that are different from the truth (facts). Data reliability is considered to have a great impact on service quality. Therefore, technologies to enhance data reliability are being developed.

For example, there are known systems that match the needs of personnel recruiters and job seekers. There are also known systems that evaluate the sales capability of an organization including sales personnel and a manager that manages the sales personnel using a plurality of common evaluation items that are independent of organizational hierarchy (see Japanese Unexamined Patent Application Publication No. 2010-176610 (JP 2010-176610 A), for example).

According to the sales capability evaluation device according to JP 2010-176610 A, each person inputs question evaluation points determined by evaluating himself/herself for questions in a questionnaire. The device calculates respective self-evaluation points for the evaluation items from the question evaluation points according to the correspondence of the question contents. The device inputs answer evaluation points and visual evaluation points determined from the viewpoint of each hierarchical level according to the correspondence of the question contents. The device calculates respective objective evaluation points for the evaluation items from the answer evaluation points and the visual evaluation points. In the sales capability evaluation device according to JP 2010-176610 A, furthermore, respective average points of the self-evaluation points and the objective evaluation points are calculated for the evaluation items for each organizational hierarchical level. The average points are determined as final scores.

It is conceivable to evaluate characteristic items of a user using data such as those described above. For example, it may be possible to accurately evaluate user characteristics by using not only evaluation information self-reported by the user but also evaluation information determined by others for characteristic items of the user to be evaluated (such as English conversation and programming; hereinafter also referred to as “user characteristics”). Furthermore, it is considered that subjective evaluation should be given a high value for some items, depending on the content of the user characteristics.

In the sales capability evaluation device according to JP 2010-176610 A, however, the average points of the self-evaluation points and the objective evaluation points are determined as final scores for evaluation indicators of the user characteristics. Thus, the subjective evaluation determined by the user and the objective evaluation determined by the other users are treated uniformly. Therefore, there is an issue that evaluation indicators (e.g., national qualifications etc.) that should be given a high value when evaluating user characteristics (here, sales capability) are not considered appropriately.

Furthermore, for some evaluation items for which a self-evaluation score determined by the user should be given priority, such as “my favorites”, the evaluation score may be varied by the intervention of evaluations by the other users. This poses an issue that the accuracy of the final score of the user may be reduced.

Furthermore, variations in self-evaluation are not taken into account. There may be a difference in evaluation scale between users with high self-evaluation and users with modest self-evaluation, depending on the evaluation item. There is an issue that it is difficult to accurately evaluate user characteristics. Furthermore, the reliability of other users that evaluate a certain user is not taken into account. There is an issue that, when user characteristics of a user are evaluated by another malicious user, the evaluated user characteristics cannot be evaluated accurately.

### SUMMARY

The present disclosure has been made to address such issues. The present disclosure has an object to provide an information processing device, an information processing method, and a storage medium that can appropriately treat evaluations of characteristic items of a user by other users, and that can optimize characteristic items (evaluation items) overestimated or underestimated by the user. These can improve accuracy in evaluating the characteristic items of the user.

An aspect of the present disclosure provides an information processing device including:
an information storage unit that stores information about a user and information about actions of other users regarding the information about the user;
a data acquisition unit that acquires information regarding a characteristic item, among the information about the user and the information about the actions of the other users, from the information storage unit; and
a user characteristic score calculation unit that calculates a user evaluation score about the characteristic item based on the information about the user and the information about the actions of the other users regarding the characteristic item, in which
the user characteristic score calculation unit includes:
a self-evaluation score calculation unit that calculates a self-evaluation score determined by the user based on the information about the user regarding the characteristic item;
an other-evaluation score calculation unit that calculates an other-evaluation score determined by the other users based on the information about the actions of the other users regarding the characteristic item; and
a final evaluation score calculation unit that sets respective weighting coefficients for the self-evaluation score and the other-evaluation score according to the characteristic item, and that calculates the user evaluation score about the characteristic item based on the set weighting coefficients, the self-evaluation score, and the other-evaluation score.

With the above configuration, the information processing device according to the aspect of the present disclosure calculates a user evaluation score by applying respective weighting coefficients to the self-evaluation score determined by the user himself/herself and the other-evaluation score determined by the other users. This can improve accuracy in evaluating the characteristic items of the user.

In the information processing device according to the aspect of the present disclosure, the information storage unit may store a plurality of characteristic items as the characteristic item. In this case, the final evaluation score calculation unit may set the respective weighting coefficients based on rules or machine learning, depending on a type of the characteristic items. Since the weighting coefficients are set according to circumstances in this manner, it is possible to further improve accuracy in evaluating the characteristic items of the user.

In the information processing device according to the aspect of the present disclosure, the user characteristic score calculation unit may perform preprocessing on text data acquired by the data acquisition unit using a word vector dictionary.

An aspect of the present disclosure provides an information processing method including:
acquiring information regarding a characteristic item, among information about a user and information about actions of other users, from an information storage unit;
calculating a self-evaluation score determined by the user based on the information about the user regarding the characteristic item;
calculating an other-evaluation score determined by the other users based on the information about the actions of the other users regarding the characteristic item;
setting respective weighting coefficients for the self-evaluation score and the other-evaluation score according to the characteristic item; and
calculating a user evaluation score about the characteristic item based on the set weighting coefficients, the self-evaluation score, and the other-evaluation score.

An aspect of the present disclosure provides a storage medium storing an information processing program that causes an information processing device to execute processes including:
acquiring information regarding a characteristic item, among information about a user and information about actions of other users, from an information storage unit;
calculating a self-evaluation score determined by the user based on the information about the user regarding the characteristic item;
calculating an other-evaluation score determined by the other users based on the information about the actions of the other users regarding the characteristic item;
setting respective weighting coefficients for the self-evaluation score and the other-evaluation score according to the characteristic item; and
calculating a user evaluation score about the characteristic item based on the set weighting coefficients, the self-evaluation score, and the other-evaluation score.

With the present disclosure, it is possible to provide an information processing device, an information processing method, and a storage medium that can appropriately treat evaluations of characteristic items of a user by other users, and that can optimize characteristic items (evaluation items) overestimated or underestimated by the user. These can improve accuracy in evaluating the characteristic items of the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of an information processing device according to an embodiment;

FIG. 2 is an example of estimating the degree of relevance of replies in consideration of semantic categories according to the embodiment;

FIG. 3 is an example of scoring for user attributes according to the embodiment; and

FIG. 4 is a flowchart showing an example of a scoring process executed by the information processing device shown in FIG. 1.

### DETAILED DESCRIPTION OF EMBODIMENTS

### Embodiment

Hereinafter, embodiments of the present disclosure will be described with reference to the drawings. However, the claimed disclosure is not limited to the following embodiments. Further, not all of the configurations described in the embodiments are essential as means for solving the problem. In order to clarify the explanation, the following description and drawings have been omitted or simplified as appropriate. In each drawing, the same elements are designated by the same reference signs, and duplicate explanations are omitted as necessary.

### Configuration of Information Processing Device

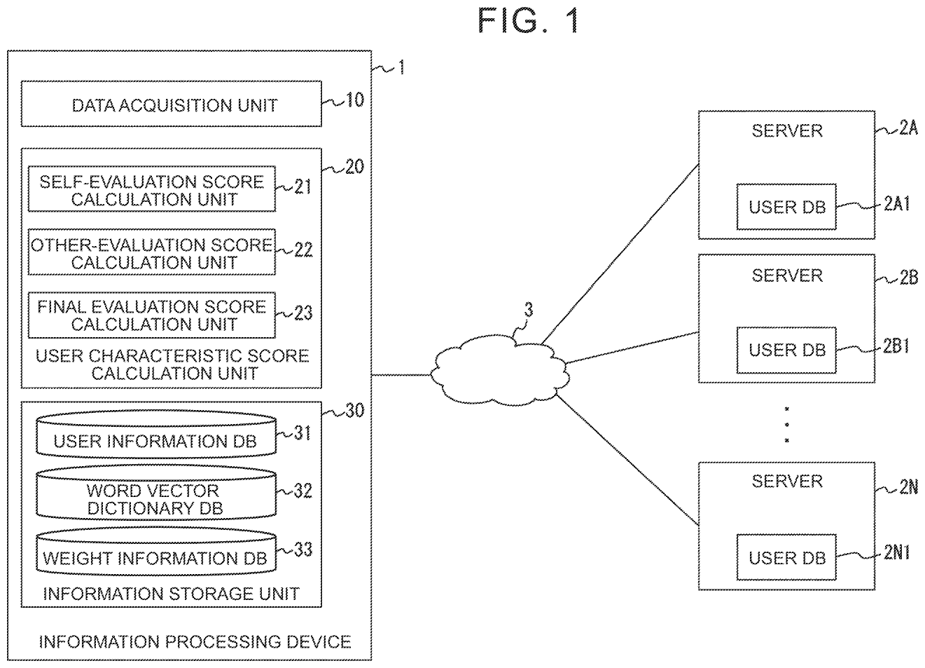

First, the configuration of the information processing device according to this embodiment will be explained. FIG. 1 is a block diagram showing the configuration of an information processing device 1 according to this embodiment. The configuration of an information processing device 1 according to this embodiment will be described with reference to FIG. 1.

As shown in FIG. 1, an information processing device 1 according to the present embodiment is a device for providing a service for processing user information of registered users, and includes a data acquisition unit 10, a user characteristic score calculation unit 20, and an information storage unit 30. The information processing device 1 may be connected to servers 2A, 2B-2N for providing social networking services (SNS) via a network 3 such as the Internet. Each of the servers 2A, 2B-2N is, for example, a server that provides services such as Twitter (registered trademark), Instagram (registered trademark), TikTok (registered trademark), YouTube (registered trademark), or Facebook (registered trademark).

The servers 2A, 2B-2N include user databases 2A1, 2B1-2N1, respectively, for storing user information. The user databases 2A1, 2B1-2N1 store user information of each user who uses each SNS. Note that the information processing device 1 is configured to allow each user of the information processing device 1 to set whether to permit access by the information processing device 1 to the user information of the user stored in the user databases 2A1, 2B1-2N1 of the respective servers 2A, 2B-2N. If the user allows access by the information processing device 1 (for example, a link to the user page of each SNS is posted in the user information of the information processing device 1), the information processing device 1, which will be described later, In the scoring process to be performed, the information processing device 1 can directly acquire user information not only from the information storage unit 30 but also from the user databases 2A1, 2B1-2N1.

The information storage unit 30 stores information regarding the user and information regarding the actions of other users with respect to the information regarding the user. As shown in FIG. 1, the information storage unit 30 includes a user information database 31, a word vector dictionary database 32, and a weight information database 33.

The user information database 31 stores, as information regarding users, for example, user attribute information, user self-evaluation information, user behavior history information, and user feedback information. The user attribute information includes, for example, each user's name, age, address, gender, skill, special skill, and the like. Note that the user information database 31 may also store access information to the user databases 2A1, 2B1-2N1 of the respective servers 2A, 2B-2N as user attribute information.

The user self-evaluation information includes information on the user's self-evaluation of characteristic items such as skills and special skills in the user attribute information of each user. As a user's self-evaluation, for example, degree information such as “not at all,” “somewhat so,” and “completely so” is added to each characteristic item.

The user behavior history information includes, for example, information about each user viewing an item, information about clicking an item icon, etc. in the service provided by the information processing device 1. On the other hand, user feedback information is information regarding actions performed by other users within a page published by each user. Here, the items include, for example, a heart mark emoticon, a smile mark emoticon, a medal emoticon, and the like. Note that a user's account image, an image posted to SNS, or the like may be used as the item. Since the account image set on SNS is useful information, it is expected that this account image can be used to infer the user's personality and inner feelings.

User feedback information includes, for example, reactions and replies by other users to certain user attribute information. Reactions include adding a smiley face or heart emoticon to a post, or clicking the “like” button. Replies include direct messages such as “I'm so excited about your infinite possibilities!”, “I'm rooting for you”, “This skill of yours is amazing”, and “Your work has helped me”.

The word vector dictionary database 32 stores a word vector dictionary used in data preprocessing, which will be described later. A word vector dictionary (also referred to as a “word meaning vector dictionary”) is a dictionary that compresses the dimension by converting words into vector representations using machine learning or the like in order to capture the meanings of words. The word vector dictionary enables the measurement of similarity between words as described below. Utilization of this degree of similarity mainly makes it possible to calculate the evaluation score of others regarding replies.

The weight information database 33 stores weight information for the user's own self-evaluation and weight information for other users' evaluations of the user with respect to each characteristic item such as skills and special skills in the user attribute information. A specific example of the weight information will be described later.

The data acquisition unit 10 is configured to acquire information regarding characteristic items of each user from the user information database 31 of the information storage unit 30 among the information regarding the user and the information regarding the behavior of other users stored in the information storage unit 30. In the present embodiment, the data acquisition unit 10 acquires information regarding characteristic items of the target user from the user information database 31 of the information storage unit 30 in response to an operation of the user or another user on a mobile terminal or computer (not shown). Here, the characteristic items are skills, special skills, interest levels, interests, strengths, weaknesses, etc. of each user stored in the user information database 31. Each characteristic item is an item that can be evaluated by each user and other users. In this way, a plurality of characteristic items are set in the user information database 31 of the information storage unit 30 and stored as necessary. Note that the characteristic item is also a meaning category assigned by the user himself, as described later.

The data acquisition unit 10 is configured to perform preprocessing on information (data) regarding the acquired characteristic items. As preprocessing, the data acquisition unit 10 formats the acquired text data. For example, the data acquisition unit 10 unifies full-width/half-width text data, or unifies English/Japanese (katakana) notation, as in Twitter, Twitter (registered trademark), etc. The data acquisition unit 10 also aggregates synonyms and higher/lower concepts for each acquired word. For example, the data acquisition unit 10 may aggregate a superordinate concept (citrus) and a subordinate concept (tangerine, orange) for words such as citrus, tangerine, and orange. Note that in such aggregation, words may be classified based on superior/subordinate relationships, part/whole relationships, synonymous relationships, similar meaning relationships, etc., using a thesaurus constructed by an expert. Building a thesaurus is expensive. Thesaurus does not correspond to the latest words. Instead of using a thesaurus, the degree of similarity between words may be measured from the word embedding representation (positioning of the words in the real vector space), and if the degree of similarity is greater than or equal to a threshold, the words may be considered synonyms.

The user characteristic score calculation unit 20 is configured to calculate a user evaluation score for a characteristic item based on information regarding each user with respect to the characteristic item and information regarding the behavior of other users. In the present embodiment, the user characteristic score calculation unit 20 calculates the user self-evaluation information stored in the user information database 31 of the information storage unit 30, the user Using behavior history information, user feedback information, etc., a user evaluation score of the corresponding user is calculated. As shown in FIG. 1, the user characteristic score calculation unit 20 includes a self-evaluation score calculation unit 21, an other-evaluation score calculation unit 22, and a final evaluation score calculation unit 23.

The self-evaluation score calculation unit 21 is configured to calculate a self-evaluation score by each user based on information regarding each user with respect to characteristic items. The self-evaluation score calculation unit 21 uses the degree of each user's own meaning category (characteristic item) acquired by the data acquisition unit 10 as it is as a self-evaluation score. For example, each user may set 1 for the highest evaluation and 0 for the lowest evaluation for each meaning category. Further, the self-evaluation score calculation unit 21 may be configured to be able to scale the evaluation value according to the number of evaluation stages of the meaning category to be evaluated. For example, if the number of evaluation stages is 5, there are five evaluation values, namely, 0, 0.25, 0.5, 0.75, and 1.

The other-evaluation score calculation unit 22 is configured to calculate the other-person evaluation score by other users based on information regarding the behavior of other users with respect to the characteristic item. For example, the other-evaluation score calculation unit 22 may use the user behavior history information of each user and the user feedback information of other users to the user to link the meaning category self-evaluated by the user. In this case, the other-evaluation score calculation unit 22 uses the word vector dictionary stored in the word vector dictionary database 32 of the information storage unit 30 to link the word vector dictionary with the meaning category, thereby calculating the evaluation score.

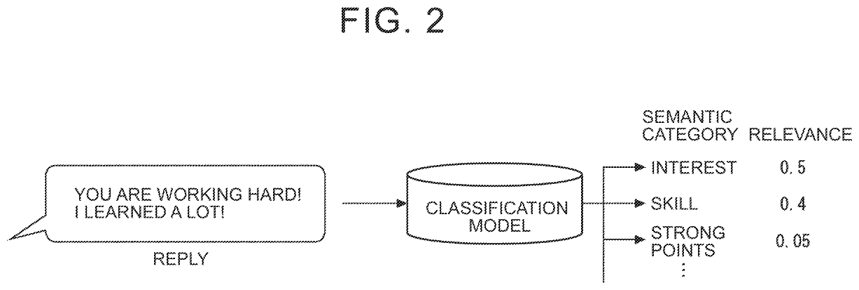

Here, an example of the operation of the other-evaluation score calculation unit 22 will be explained. FIG. 2 is an example of estimating the degree of relevance of replies in consideration of the semantic categories according to the present embodiment. As shown in FIG. 2, in order to associate replies from other users with semantic categories, it is sufficient to consider the replies as a document classification problem using text input and label them. In this example, a classification model is used to classify the reply “You're working hard! I learned a lot!” into semantic categories. In this example, if the degree of relevance of interest is 0.5 and the degree of relevance of skill is 0.4, then the degree of relevance for two meaning categories is already 0.9. Therefore, this reply is presumed to be related to interests and skills. Note that the other-evaluation score calculation unit 22 may use, for example, naïve Bayes using Bag of Words as machine learning to estimate the degree of relevance of replies, or deep learning using word embedding representation. (Deep Neural Network) may also be used. Furthermore, since the meaning obtained through machine learning may differ depending on the context, the other-evaluation score calculation unit 22 may embed not only the text of the reply itself, but also the contexts before and after the reply, or all the contexts, into the input.

The final evaluation score calculation unit 23 is configured to set weighting coefficients regarding the self-evaluation score and the other-person evaluation score, respectively, according to each characteristic item. The weighting coefficients include a weighting coefficient w1 for the self-evaluation score and a weighting coefficient w2 for the other-person evaluation score. As a method for determining this weighting coefficient, either one of two types, rule-based and machine learning-based, may be used.

First, a rule-based weighting determination method will be explained. In the rule-based weighting determination method, the weighting coefficients w1 and w2 are determined by the user (administrator) of the information processing device 1, for example. In this case, the administrator of the information processing device 1 defines characteristic items for which emphasis should be placed on self-evaluation scores and characteristic items on which emphasis should be placed on others' evaluation scores, and based on these definitions, the administrator of the information processing device 1 determines the weighting coefficient of each characteristic item. It is sufficient to set w1 and w2.

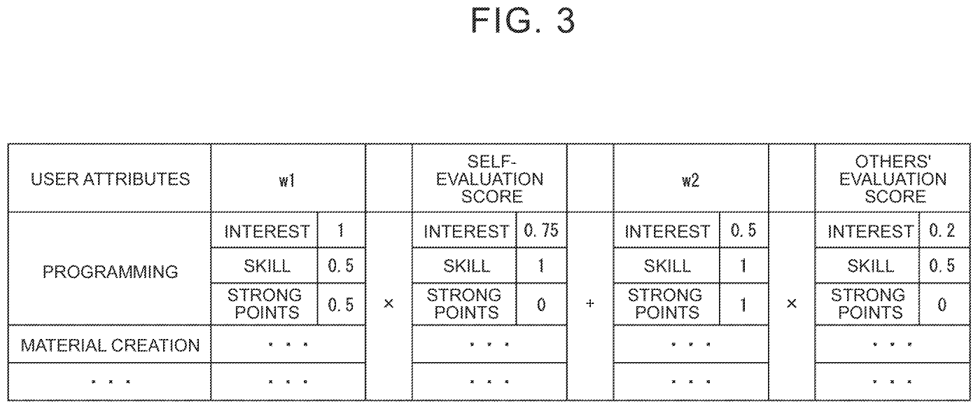

Here, a method of calculating the final user evaluation score (hereinafter also referred to as “final user evaluation score”) using a rule-based weighting determination method by the final evaluation score calculation unit 23 will be described. FIG. 3 is an example of scoring for user attributes according to this embodiment. Here, a case is shown in which a user evaluation score is calculated for “programming” as a user attribute. For the user attribute “Programming,” “interest” is determined by the user himself, so the self-evaluation score should be emphasized. Therefore, the final evaluation score calculation unit 23 sets the weighting coefficient w1 of the self-evaluation score and the weighting coefficient w2 of the other-person evaluation score to 1 and 0.5, respectively. Furthermore, for the user attribute “programming”, “skill” should be determined by other users, so it seems better to place emphasis on the evaluation score by others. Therefore, the final evaluation score calculation unit 23 sets the weighting coefficient w1 of the self-evaluation score and the weighting coefficient w2 of the other-person evaluation score to 0.5 and 1, respectively. In this way, the weighting coefficients w1 and w2 for each score are set for each characteristic item by the administrator of the information processing device 1.

Next, a machine learning-based weighting determination method will be described. In the machine learning-based weighting determination method, the weighting coefficients w1 and w2 are determined based on learned data, for example. As the initial values of the weighting coefficients w1 and w2, values set by the administrator of the information processing device 1 may be used, for example, as in a rule-based weighting determination method, or values set randomly may be used. Then, the final evaluation score calculation unit 23 uses reinforcement learning to calculate the results based on future user reactions (clicks by the user, reactions and replies by other users, etc.) and the currently set weighting coefficients w1 and w2. The model is trained so that the calculated self-evaluation score and others' evaluation score are similar, and the weighting coefficients w1 and w2 are tuned (adjusted) at each learning timing.

For example, regarding a certain user's characteristic item “Programming,” assume that when another user replies, “You are very good at programming,” the weighting coefficient w2 is set to 0.9 by machine learning by the final evaluation score calculation unit 23. After that, when another user replies, “This person can't program that well,” machine learning is performed by the final evaluation score calculation unit 23, and tuning is performed such that the weighting coefficient w2 is reduced from 0.9 to 0.6.

Further, the final evaluation score calculation unit 23 is configured to calculate the final user evaluation score regarding the characteristic items of the user to be evaluated based on the weighting coefficient, self-evaluation score, and other-person evaluation score set as described above. Specifically, the final evaluation score calculation unit 23 calculates the final user evaluation score for a certain characteristic item as follows. (Final user evaluation score)=w1×(self-evaluation score)+w2×(other-person evaluation score)

Here, the other-person evaluation scores calculated by the other-evaluation score calculation unit 22 exist as many as the number of other users who have evaluated the characteristic items of the target user. Therefore, when the other-evaluation score calculation unit 22 calculates the other-person evaluation scores by a plurality of other users, the final evaluation score calculation unit 23 calculates, for example, the other-person evaluation scores of the plurality of other users. The average value is applied to the above formula as the overall others' evaluation score.

Note that the other-person evaluation score may be calculated using another method instead of using the average value of the other-person evaluation scores of a plurality of other users. For example, a score related to evaluation (hereinafter referred to as “evaluation-related score”) is set for another user (hereinafter also referred to as “evaluator”) who has evaluated a characteristic item of a certain user, and based on this score, an overall An evaluation score by others may be calculated. Specifically, the evaluation-related score may be calculated using the number of evaluations by each evaluator, with the maximum number of evaluations by all evaluators as the denominator and the number of evaluations by each evaluator as the numerator. Thereby, the degree of influence each evaluator has on the system of the information processing device 1 is taken into consideration.

Furthermore, based on the degree of association between each evaluator and the evaluation target, an evaluation related score may be calculated by adding points to evaluators with the same department, background, and expertise. Evaluators from the same department are considered to have high accuracy in their evaluation of the evaluation target. Taking into account factors such as the length of time employees have been in the same department further improves evaluation accuracy. For evaluators with the same expertise, the word vector dictionary stored in the word vector dictionary database 32 is used to measure the degree of similarity between the specialized fields of the evaluator and the evaluator, and the degree of similarity is directly applied to the evaluator. You may add points to the evaluation points. Alternatively, if the degree of similarity is greater than or equal to a threshold value, points may be added to the evaluation score of the evaluator.

Furthermore, the final user evaluation score evaluated using the weighting coefficients w1 and w2 calculated based on the rules, the final user evaluation score evaluated using the weighting coefficients w1 and w2 calculated based on the machine learning, and the evaluation score of each evaluator. The evaluation-related score of each evaluator may be adjusted based on the error. For example, an evaluator who gives an evaluation score that is significantly different from the final user evaluation score is considered to be a malicious evaluator. By lowering the evaluation of such a malicious evaluator, it is possible to improve the accuracy in evaluating the characteristic items of the evaluation target.

Note that, without using the weighting coefficient w2 for the other-person evaluation score set by the administrator of the information processing device 1 on a rule basis or the weighting coefficient w2 for the other-person evaluation score adjusted on the machine learning basis, other A comprehensive evaluation score by others may be calculated by the user. For example, calculate the average of the other-person evaluation scores of all evaluators, calculate how much variance there is as a standard deviation based on the error between the average others-evaluation score and the other-person evaluation scores of each evaluator, The other-person evaluation scores by each evaluator may be weighted based on the standard deviation.

In the machine learning-based weighting determination method, when the final evaluation score calculation unit 23 calculates the weighting coefficients w1 and w2, it overwrites and saves the calculated weighting coefficients w1 and w2 in the weight information database 33, and the calculated weighting coefficients w1 and w2 can be used when calculating the next final user evaluation score.

### Operation of Information Processing Device

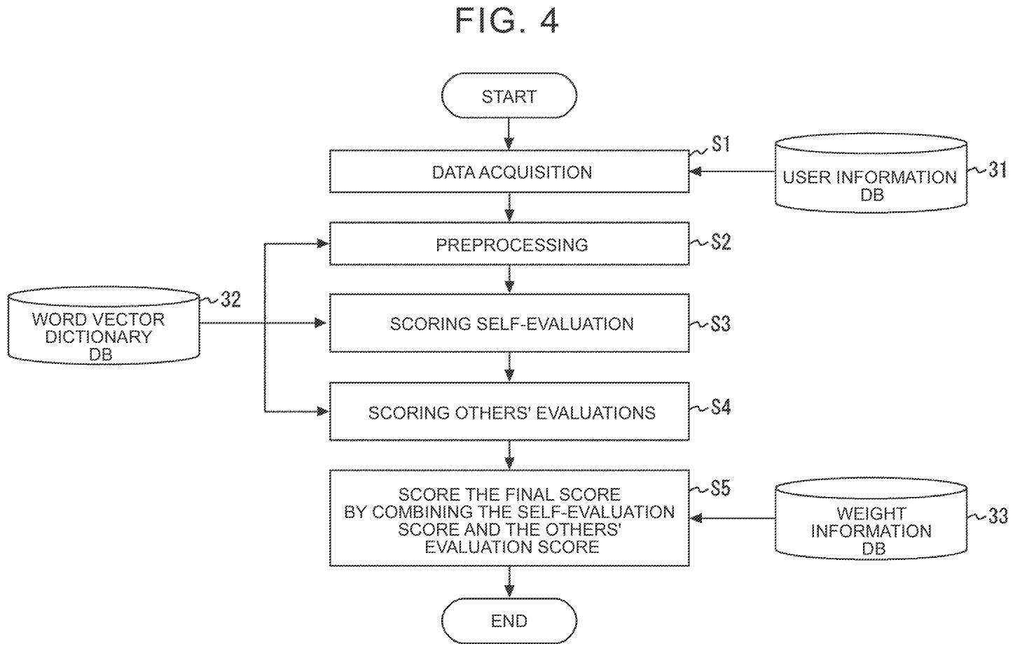

Next, an example of the operation of the information processing device 1 according to this embodiment will be described. FIG. 4 is a flowchart showing an example of the scoring process executed by the information processing device 1 shown in FIG. 1. This scoring process may be performed, for example, in response to evaluations made by other users on characteristic items of a certain user. The scoring process may be performed in response to an operation on a mobile terminal or computer (not shown) by another user who wants to check the characteristic items of the user.

When the scoring process is started, the data acquisition unit 10 retrieves, among the information regarding the user and the information regarding the behavior of other users stored in the information storage unit 30, information regarding the characteristic items of each user from the user information database 31 of the information storage unit 30 (S1).

Next, the data acquisition unit 10 uses the word vector dictionary stored in the word vector dictionary database 32 to perform preprocessing on the information (data) regarding the acquired characteristic items. The data acquisition unit 10 collects synonyms and higher/lower concepts for each word (S2).

Next, the self-evaluation score calculation unit 21 of the user characteristic score calculation unit 20 scores the user's self-evaluation in the characteristic items of the user to be evaluated (S3). Specifically, the self-evaluation score calculation unit 21 calculates the self-evaluation score of each user based on information regarding each user with respect to characteristic items stored in the user information database 31 of the information storage unit 30. In this case, the user characteristic score calculation unit 20 may use a word vector dictionary stored in the word vector dictionary database 32, if necessary.

Next, the other-evaluation score calculation unit 22 of the user characteristic score calculation unit 20 scores the other-person evaluation by other users on the characteristic items of the user to be evaluated (S4). Specifically, the other-evaluation score calculation unit 22 calculates other-person evaluation scores by other users for the characteristic items of the user to be evaluated using user action history information of the user to be evaluated, user feedback information of other users to the user, and, if necessary, the word vector dictionary database 32.

Next, the final evaluation score calculation unit 23 of the user characteristic score calculation unit 20 sets weighting coefficients w1 and w2 regarding the self-evaluation score and the other-person evaluation score, respectively, according to each characteristic item. Then, the final evaluation score calculation unit 23 scores the final user evaluation based on the set weighting coefficients w1, w2, the self-evaluation score calculated in S3, and the other-person evaluation score calculated in S4 (S5). Specifically, the final evaluation score calculation unit 23 multiplies the self-evaluation score calculated in S3 by the weighting coefficient w1. The final evaluation score calculation unit 23 multiplies the other person evaluation score calculated in S4 by the weighting coefficient w2. The final evaluation score calculation unit 23 calculates the final user evaluation score by adding them.

As described above, the information processing device 1 according to the present embodiment includes the information storage unit 30, the data acquisition unit 10, and the user characteristic score calculation unit 20. The information storage unit 30 stores information regarding the user and information regarding the actions of other users with respect to the information regarding the user. The data acquisition unit 10 acquires information regarding characteristic items from the information storage unit 30 out of the information regarding the user and the information regarding the behavior of other users. The user characteristic score calculation unit 20 calculates a user evaluation score regarding the characteristic item based on information regarding the user with respect to the characteristic item and information regarding the behavior of other users. Here, the user characteristic score calculation unit 20 includes a self-evaluation score calculation unit 21, an other-evaluation score calculation unit 22, and a final evaluation score calculation unit 23. The self-evaluation score calculation unit 21 calculates a self-evaluation score by the user based on information regarding the user with respect to the characteristic items. The other-evaluation score calculation unit 22 calculates the other user's evaluation score by other users based on information regarding the behavior of other users with respect to the characteristic item. The final evaluation score calculation unit 23 sets weighting coefficients regarding the self-evaluation score and the other-person evaluation score, respectively, according to the characteristic item, and calculates the user evaluation score for the characteristic item based on the set weighting coefficient, self-evaluation score, and other-person evaluation score. By configuring the information processing device 1 in this way, it is possible to appropriately handle other users' evaluations of the user's characteristic items, and to optimize characteristic items (evaluation items) that are over- or under-evaluated by the user. This makes it possible to improve the accuracy in evaluating the user's characteristic items. That is, it is possible to provide a user evaluation score that is closer to the truth for the characteristic items of the user of the information processing device 1.

Furthermore, the information processing device 1 according to the present embodiment is configured to adjust the weighting of the subjective evaluation and the objective evaluation according to the user's characteristic item, and calculate the final user evaluation score of the user's characteristic item. Therefore, the information processing device 1 can evaluate the user's characteristic items, taking into consideration the dispersion and reliability of evaluations between the user himself, other users, and other evaluators.

In this way, according to the information processing device 1 according to the present embodiment, the user's characteristic items (user evaluation scores) are accurately evaluated. By using this user evaluation score, it is possible to provide a recommendation that ensures fairness to a third party (user of the information processing device 1) who is looking for a user with excellent characteristic items. That is, it is possible to suppress users who overestimate themselves, or to extract (excavate) users who underestimate themselves.

In addition, by comparing the user evaluation score regarding a certain user's characteristic item calculated by the information processing device 1 with the other users' evaluation score of each other user regarding the characteristic item of the user, it is possible to determine how close these scores are. Based on how, the evaluators within the service can be evaluated inversely. This makes it possible to extract competent evaluators for each characteristic item.

Further, in another aspect of the present disclosure, an information processing method is provided. The information processing method of the present disclosure includes acquiring information regarding a characteristic item from the user information database 31 of the information storage unit 30 out of information regarding the user and information regarding the behavior of other users; calculating a self-evaluation score by a user; calculating a score evaluated by other users by other users based on information regarding the behavior of other users with respect to a characteristic item; setting weighting coefficients regarding self-evaluation scores and other-person evaluation scores according to the characteristics item; and calculating user evaluation scores regarding characteristic items based on the set weighting coefficients, self-evaluation scores, and other-person evaluation scores. By configuring the information processing method in this way, the same effects as the information processing device 1 described above can be achieved.

Part or all of the processing in the information processing device 1 described above can be realized as a computer program (information processing program). The program as described above is stored using various types of non-transitory computer-readable media, and can be supplied to a computer. The non-transitory computer-readable media include various types of tangible recording media (storage media). Examples of non-transitory computer-readable media include magnetic recording media (e.g., flexible disks, magnetic tape, hard disk drives), magneto-optical recording media (e.g., magneto-optical disks), Read Only Memory (CD-ROM), CD-ROM, etc. R, CD-R/W, semiconductor memory (e.g., mask ROM, programmable ROM (PROM), erasable PROM (EPROM), flash ROM, random access memory (RAM)). Further, the program may also be supplied to the computer by various types of transitory computer-readable media. Examples of the transitory computer-readable media include electrical signals, optical signals, and electromagnetic waves. The temporary computer-readable medium can provide the program to the computer via wired communication channels, such as electrical wires and optical fibers, or wireless communication channels.

Although the present disclosure has been described with reference to the embodiments, the present disclosure is not limited to the above embodiments, and can be modified as appropriate without departing from the spirit.

The information processing device, etc. according to the present disclosure can be applied to improve the accuracy of evaluation of characteristic items of a certain user by optimizing self-evaluation and others' evaluation of the characteristic items of the user.

What is claimed is:

1. An information processing device comprising:
an information storage unit that stores information about a user and information about actions of other users regarding the information about the user;
a data acquisition unit that acquires information regarding a characteristic item, among the information about the user and the information about the actions of the other users, from the information storage unit; and
a user characteristic score calculation unit that calculates a user evaluation score about the characteristic item based on the information about the user and the information about the actions of the other users regarding the characteristic item, wherein the user characteristic score calculation unit includes:
a self-evaluation score calculation unit that calculates a self-evaluation score determined by the user based on the information about the user regarding the characteristic item;
an other-evaluation score calculation unit that calculates an other-evaluation score determined by the other users based on the information about the actions of the other users regarding the characteristic item; and
a final evaluation score calculation unit that sets respective weighting coefficients for the self-evaluation score and the other-evaluation score according to the characteristic item, and that calculates the user evaluation score about the characteristic item based on the set weighting coefficients, the self-evaluation score, and the other-evaluation score.

2. The information processing device according to claim 1, wherein:
the information storage unit stores a plurality of characteristic items as the characteristic item; and
the final evaluation score calculation unit sets the respective weighting coefficients based on rules or machine learning, depending on a type of the characteristic items.

3. The information processing device according to claim 1, wherein the user characteristic score calculation unit performs preprocessing on text data acquired by the data acquisition unit using a word vector dictionary.

4. An information processing method comprising:
acquiring information regarding a characteristic item, among information about a user and information about actions of other users, from an information storage unit;
calculating a self-evaluation score determined by the user based on the information about the user regarding the characteristic item;
calculating an other-evaluation score determined by the other users based on the information about the actions of the other users regarding the characteristic item;
setting respective weighting coefficients for the self-evaluation score and the other-evaluation score according to the characteristic item; and
calculating a user evaluation score about the characteristic item based on the set weighting coefficients, the self-evaluation score, and the other-evaluation score.

5. A non-transitory storage medium storing an information processing program that causes an information processing device to execute processes comprising:
acquiring information regarding a characteristic item, among information about a user and information about actions of other users, from an information storage unit;
calculating a self-evaluation score determined by the user based on the information about the user regarding the characteristic item;
calculating an other-evaluation score determined by the other users based on the information about the actions of the other users regarding the characteristic item;
setting respective weighting coefficients for the self-evaluation score and the other-evaluation score according to the characteristic item; and
calculating a user evaluation score about the characteristic item based on the set weighting coefficients, the self-evaluation score, and the other-evaluation score.
